(19) United States
(12) Patent Application Publication
(10) Pub. No.: US 2026/0320245 A1
(43) Pub. Date: Oct. 15, 2026

(54) SIMULATION SYSTEM AND SIMULATING METHOD FOR VEHICLE CHARGING BEHAVIOR DATA IN CHARGING STATION

(71) Applicants: LITE-ON SINGAPORE PTE.LTD., Singapore (SG); LITE-ON TECHNOLOGY CORPORATION, Taipei (TW)

(72) Inventors: Wei CIOU, Taipei (TW); Ken Weng Kow, Singapore (SG); Tse-Chun Wang, Taipei (TW)

(21) Appl. No.: 19/360,570

(22) Filed: Oct. 16, 2025

Related U.S. Application Data
(60) Provisional application No. 63/785,705, filed on Apr. 9, 2025.

(30) Foreign Application Priority Data
Aug. 14, 2025 (CN) 202511139741.2

(51) Int. Cl. G06F 30/20; G06F 111/08; G06F 113/04; G06Q 50/06; H02J 3/00; H02J 103/30

(52) U.S. Cl. CPC G06F 30/20; G06Q 50/06; H02J 3/003; G06F 2111/08; G06F 2113/04; H02J 2103/30

(57) ABSTRACT

A simulation system and a simulating method for vehicle charging behavior data in a charging station are provided. The simulation system includes a vehicle group determining unit, an arrival time simulation unit, a duration stay simulation unit and a charging demand simulation unit. The vehicle group determining unit is used to determine a vehicle group of a vehicle. The arrival time simulation unit is used to obtain a simulation arrival time of the vehicle according to the vehicle group. The duration stay simulation unit is used to obtain a simulation duration stay of the vehicle according to the vehicle group. The charging demand simulation unit is used to obtain a simulation charging demand of the vehicle according to the vehicle group.

This application claims the benefit of U.S. Provisional application Ser. No. 63/785,705, filed Apr. 9, 2025, and the China application Serial No. 202511139741.2, filed Aug. 14, 2025, disclosure of which is incorporated by reference herein in its entirety.

### TECHNICAL FIELD

The disclosure relates in general to a simulation system and a simulating method, and more particularly to a simulation system and a simulating method for vehicle charging behavior data in a charging station.

### BACKGROUND

To effectively manage energy and reduce operating costs, charging stations typically rely on models for inference and scheduling when planning charging and discharging activities. These models could help determine when to charge or discharge based on information such as predicted electricity demand, electricity price fluctuations, and renewable energy generation, thereby achieving load balancing and optimizing performance. Therefore, intelligent model inference plays a key role in charging station operational planning.

However, building accurate inference models requires extensive, representative real-world data. This data, which typically covers factors such as traffic patterns, electricity consumption, and weather variations, is challenging to collect and often requires extensive observation and accumulation. Consequently, the process of implementing a charging station, from design to operational implementation, often takes a year or more due to insufficient data and lengthy model validation processes.

### SUMMARY

The disclosure is directed to a simulation system and a simulating method for vehicle charging behavior data in a charging station. This simulation system uses appropriate clustering techniques to determine the distribution of the vehicle charging behavior data, and then simulates various information accordingly. While collecting the vehicle charging behavior data is difficult, this simulation system rapidly generates multiple sets of vehicle charging behavior data. This reduces the time required to infer a charge-discharge schedule from months to days, significantly accelerating the deployment of charging stations.

According to one embodiment, a simulating method for vehicle charging behavior data in a charging station is provided. The simulating method for the vehicle charging behavior data in the charging station includes the following steps. A vehicle group of a vehicle is determined. A simulation arrival time of the vehicle is obtained according to the vehicle group. A simulation duration stay of the vehicle is obtained according to the vehicle group. A simulation charging demand of the vehicle is obtained according to the vehicle group.

According to another embodiment, a simulation system for vehicle charging behavior data is provided. The simulation system includes a vehicle group determination unit, an arrival time simulation unit, a duration stay simulation unit and a charging demand simulation unit. The vehicle group determination unit is used for determining a vehicle group of a vehicle. The arrival time simulation unit is used for obtaining a simulation arrival time of the vehicle according to the vehicle group. The duration stay simulation unit is used for obtaining a simulation duration stay of the vehicle according to the vehicle group. The charging demand simulation unit is used for obtaining a simulation charging demand of the vehicle according to the vehicle group.

### BRIEF DESCRIPTION OF THE DRAWINGS

FIG. 1 illustrates an example of an application of vehicle charging behavior data at a charging station.

FIG. 2 shows a block diagram of a simulation system for the vehicle charging behavior data according to an embodiment of the present disclosure.

FIG. 3 illustrates a flowchart of a simulation method for the vehicle charging behavior data at the charging station according to an embodiment of the present disclosure.

FIG. 4 shows a detailed flowchart of the step S130 according to an embodiment of the present disclosure.

FIG. 5 illustrates an example of a vehicle group according to one embodiment.

FIG. 6 summarizes a behavior stability, a charging type, a charging frequency, a frequent arrival time, and a frequent duration of stay for each of the vehicle groups.

FIGS. 7A to 7B illustrates an example of the vehicle groups for a number of simulation vehicles.

FIG. 8 illustrates a detailed flowchart of the step S132 according to an embodiment of the present disclosure.

FIG. 9A illustrates a historical arrival time probability density function and two simulation arrival time probability density functions according to one embodiment of the present disclosure.

FIG. 9B illustrates the simulation arrival time probability density function after adding Gaussian variation according to an embodiment of the present disclosure.

FIG. 9C illustrates an example of a Monte Carlo algorithm.

FIG. 10 illustrates a detailed flowchart of the step S133 according to an embodiment of the present disclosure.

FIG. 11A illustrates a historical residence time cumulative distribution function according to one embodiment of the present disclosure.

FIG. 11B illustrates a historical duration stay probability density function according to an embodiment of the present disclosure.

FIG. 11C illustrates two simulation duration stay probability density functions according to an embodiment of the present disclosure.

FIG. 11D illustrates the simulation duration stay probability density function after adding the Gaussian variation according to an embodiment of the present disclosure.

FIG. 12 illustrates a detailed flowchart of the step S134 according to an embodiment of the present disclosure.

FIG. 13A illustrates a historical charging demand cumulative distribution function according to an embodiment of the present disclosure.

FIG. 13B illustrates a historical charging demand probability density function according to an embodiment of the present disclosure.

FIG. 13C illustrates two simulation charging demand probability density functions according to an embodiment of the present disclosure.

FIG. 13D illustrates the simulation charging demand probability density function after adding the Gaussian variation according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

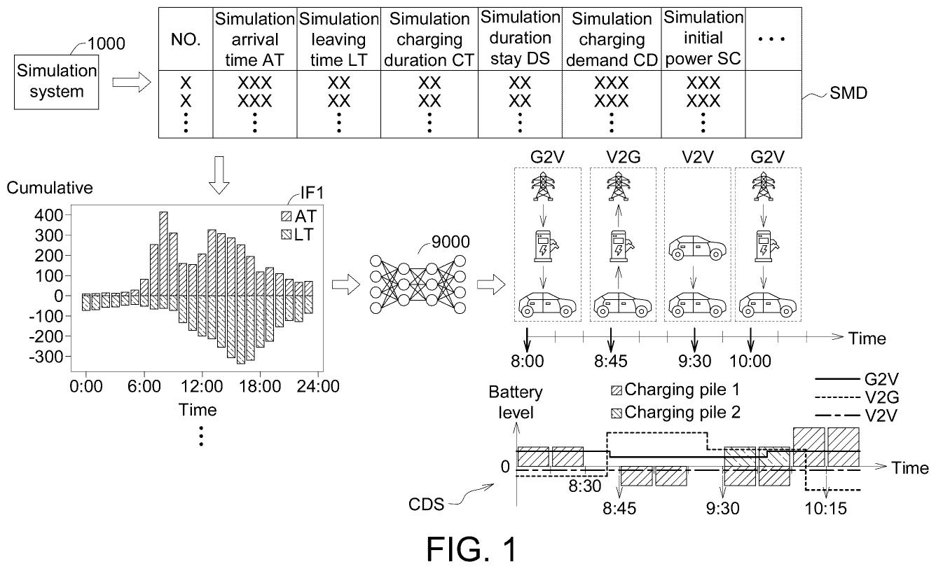

Please refer to FIG. 1, which illustrates an example of the application of vehicle charging behavior data SMD at a charging station. In this example, a simulation system 1000 could simulate the vehicle charging behavior data SMD at the charging station. This vehicle charging behavior data SMD may consist of data from tens to tens of thousands of different vehicles, representing various charging behaviors at the charging station. The simulation charging behavior includes, but is not limited to, a simulation arrival time (start time) AT, a simulation leaving time (or called end time) LT, a simulation charging duration CT, a simulation duration stay DS, a simulation charging demand CD, and a simulation initial power (or called start SOC) SC, etc.

This vehicle charging behavior data SMD could represent data collected over a specific period, such as several years, a quarter, a year, or even a single day. For example, using one year's worth of data, this vehicle charging behavior data SMD could be analyzed and presented in various statistical charts. As shown in FIG. 1, a chart information IF1 is an example of a statistical chart showing a simulation arrival time AT and the simulation leaving time LT, but it is not limited to this. This chart information IF1, or the vehicle charging behavior data SMD, could be input into a charge-discharge scheduling system 9000 to derive an optimal charge-discharge schedule CDS.

In situations where collecting real-world vehicle charging behavior data is difficult, this disclosure utilizes the simulation system 1000 to quickly generate a large amount of simulation vehicle charging behavior data SMD. This allows the derivation of the optimal charge-discharge schedule CDS to be reduced from several months to just a few days, significantly accelerating the deployment timeline for charging stations.

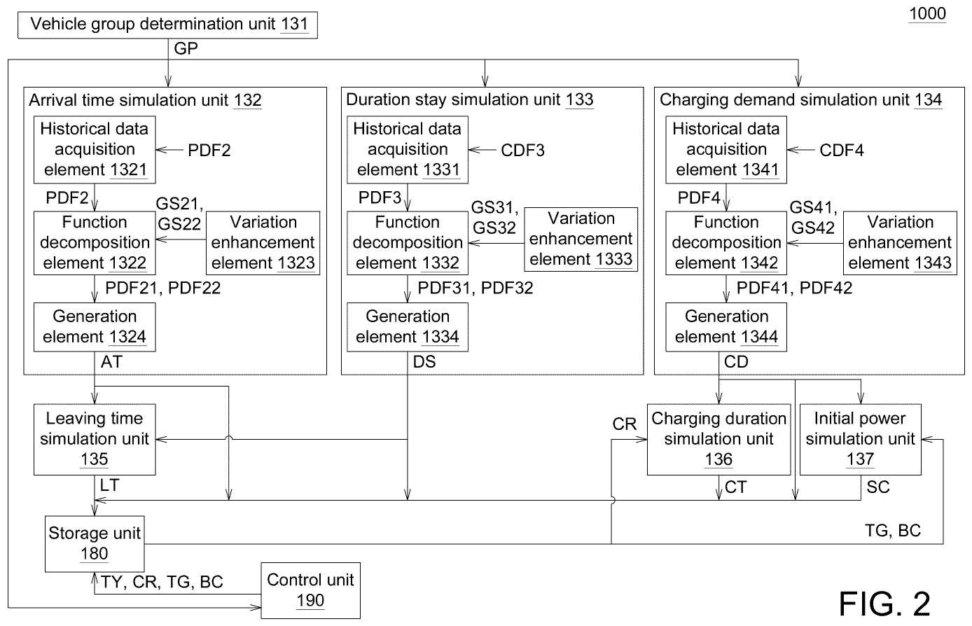

Please refer to FIG. 2, which shows a block diagram of the simulation system 1000 for the vehicle charging behavior data according to an embodiment of the present disclosure. The simulation system 1000 includes a vehicle group determination unit 131, an arrival time simulation unit 132, a duration stay simulation unit 133, a charging demand simulation unit 134, a leaving time simulation unit 135, a charging duration simulation unit 136, an initial power simulation unit 137, a storage unit 180, and a control unit 190. The vehicle group determination unit 131, the arrival time simulation unit 132, the duration stay simulation unit 133, the charging demand simulation unit 134, the leaving time simulation unit 135, the charging duration simulation unit 136, and the initial power simulation unit 137 are used for simulating various information. The control unit 190 is used for controlling the simulation process and integrating various information. The storage unit 180 is used to store data, such as any type of fixed or mobile random access memory (RAM), read-only memory (ROM), flash memory, hard disk drive (HDD), solid state drive (SSD), or similar components, or a combination thereof, for storing multiple modules or various applications that can be executed by the processor.

The vehicle group determination unit 131, the arrival time simulation unit 132, the duration stay simulation unit 133, the charging demand simulation unit 134, the leaving time simulation unit 135, the charging duration simulation unit 136, the initial power simulation unit 137, and/or the control unit 190 may be, for example, a circuit, a circuit board, a storage device containing program code, or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

The arrival time simulation unit 132 includes a historical data acquisition element 1321, a function decomposition element 1322, a generation element 1324, and a variation enhancement element 1323. The duration stay simulation unit 133 includes a historical data acquisition element 1331, a function decomposition element 1332, a generation element 1334, and a variation enhancement element 1333. The charging demand simulation unit 134 includes a historical data acquisition element 1341, a function decomposition element 1342, a generation element 1344, and a variation enhancement element 1343.

In this embodiment, the simulation system 1000 could utilize appropriate clustering techniques to determine the distribution of the vehicle charging behavior data, and then use this data to perform various simulations. A flowchart below further illustrates the operation of each component in detail.

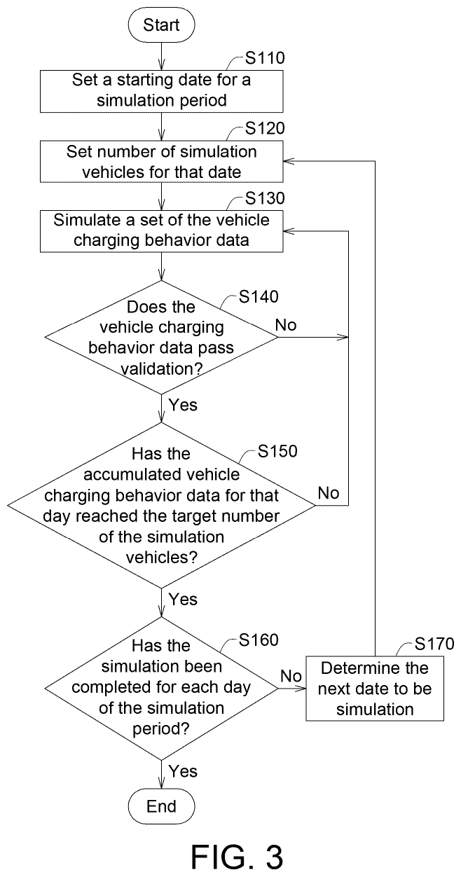

Please refer to FIG. 3, which illustrates a flowchart of a simulation method for vehicle charging behavior data at a charging station according to an embodiment of the present disclosure. The simulation method includes steps S110 to S170, for example. The simulation method could be executed by a computer, chip, firmware, or computer-readable recording medium that has loaded the corresponding program code.

In the step S110, the control unit 190 sets a starting date for a simulation period. The simulation period may be, for example, one year, one quarter, or one month. The control unit 190 may, for example, randomly select a date within the simulation period.

Next, in the step S120, the control unit 190 sets number of simulation vehicles for that date. For example, the control unit 190 could randomly select the number of the vehicles within a predetermined range.

Then, in the step S130, the control unit 190 instructs the vehicle group determination unit 131, the arrival time simulation unit 132, the duration stay simulation unit 133, the charging demand simulation unit 134, the leaving time simulation unit 135, the charging duration simulation unit 136, and the initial power simulation unit 137 to simulate a set of the vehicle charging behavior data SMD.

Next, in the step S140, the control unit 190 determines whether the vehicle charging behavior data SMD passes validation. For example, the control unit 190 could verify that the simulation duration stay DS is greater than a simulation charging duration CT, and that the simulation initial power SC is greater than 0. If the vehicle charging behavior data SMD fails validation, the process returns to the step S130; if it passes validation, the process proceeds to the step S150.

In the step S150, the control unit 190 determines whether the accumulated vehicle charging behavior data SMD for that day has reached the target number of the simulation vehicles. If not, it returns to the step S130; if it has, it proceeds to the step S160.

In the step S160, the control unit 190 determines whether the simulation has been completed for each day of the simulation period. If the simulation has been completed for all days, the process ends; otherwise, if there is any day in the simulation period for which the simulation is not yet complete, the process proceeds to the step S170.

In the step S170, the control unit 190 determines the next date to be simulation. For example, the control unit 190 may select the next date sequentially in a cyclical manner.

After the simulation for each day during the simulation period is completed, the vehicle charging behavior data SMD could be stored in the storage unit 180 or output from the storage unit 180. This vehicle charging behavior data SMD could then be input to the charge-discharge scheduling system 9000 shown in FIG. 1 to derive the optimal charge-discharge schedule CDS.

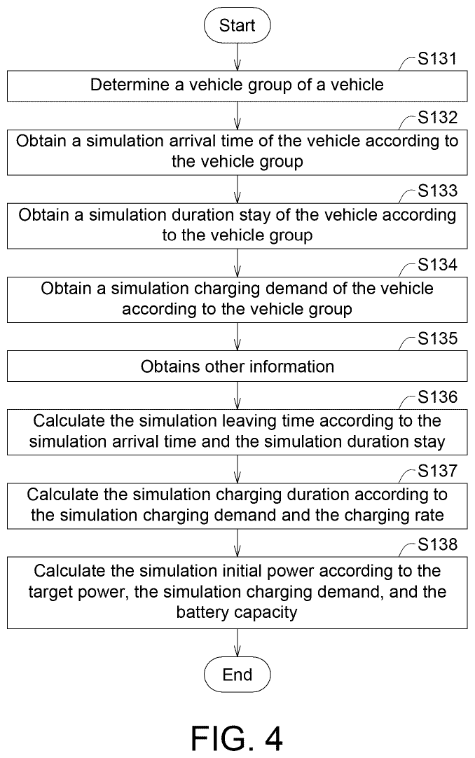

Please refer to FIG. 4, which shows the detailed flowchart of the step S130 according to an embodiment of the present disclosure. The step S130 includes, for example, steps S131 to S138.

In the step S131, the vehicle group determination unit 131 determines a vehicle group GP for a vehicle VC.

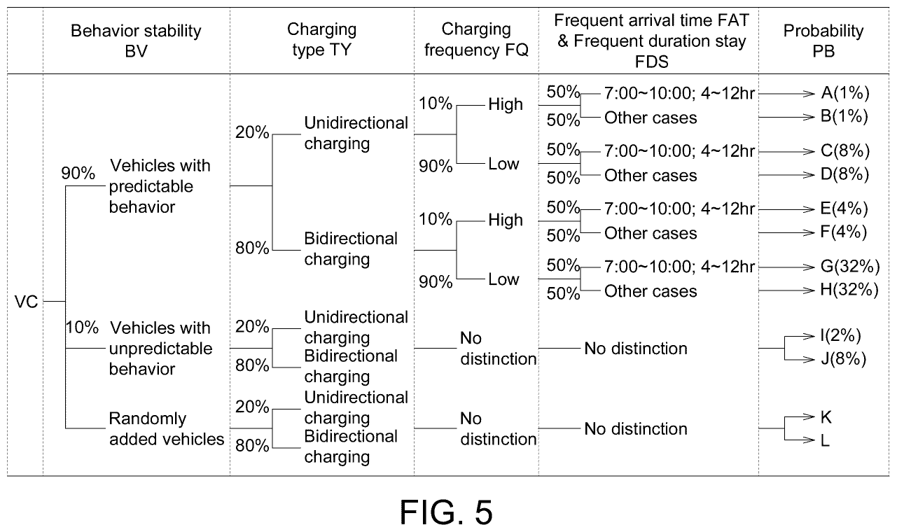

Please refer to FIG. 5, which illustrates an example of the vehicle group GP according to one embodiment. FIG. 5 is merely an example, and this disclosure is not limited to the example shown in FIG. 5. All of the vehicles VC to be simulation are classified according to a behavior stability BV, for example, as “vehicles with predictable behavior” (90%), “vehicles with unpredictable behavior” (10%), and an additional group of “randomly added vehicles.” The vehicles with predictable behavior will charge at charging stations according to a specific pattern; the vehicles with unpredictable behavior will not charge at charging stations according to a specific pattern.

Furthermore, based on a charging type TY, the vehicles are categorized as “unidirectional charging” (20%) and “bidirectional charging without specific behavior” (80%). The vehicle with unidirectional charging capability could only receive power from the power grid or other vehicles; while the vehicle with bidirectional charging capability could not only receive power from the power grid or other vehicles, but also supply power to the grid or other vehicles.

Furthermore, based on a charging frequency FQ, the vehicles could be categorized, for example, as “high-frequency charging” (10%) and “low-frequency charging” (90%). The vehicles with high-frequency charging habits typically go to charging stations when their battery level is relatively high; while the vehicles with low-frequency charging habits typically only go to charging stations when their battery level is low.

Alternatively, based on a frequent arrival time FAT and a frequent duration stay FDS, the vehicles could be categorized as “7:00-10:00; 4-12 hours” (50%) and “other cases” (50%).

According to factors such as the behavior stability BV, the charging type TY, the charging frequency FQ, the frequent arrival time FAT, and the frequent duration stay FDS, the vehicles VC could be classified into a plurality of vehicle groups GP, labeled “A” to “L”. Each of the vehicle groups GP has a corresponding probability PB.

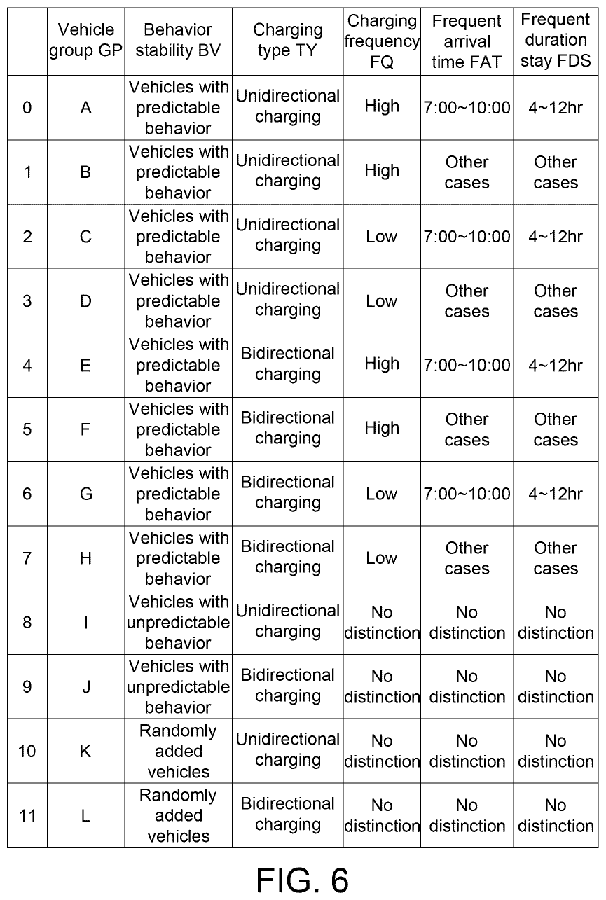

Please refer to FIG. 6, which summarizes the behavior stability BV, the charging type TY, the charging frequency FQ, the frequent arrival time FAT, and the frequent duration stay FDS for each of the vehicle groups GP. For example, for the vehicle group GP labeled “A”, the behavior stability BV is “has a fixed pattern,” the charging type TY is “one-way charging,” the charging frequency FQ is “high frequency,” the frequent arrival time FAT is “7:00-10:00,” and the frequent duration stay FDS is “4-12 hours”; for vehicle group GP labeled “B”, the behavior stability BV is “has a fixed pattern,” the charging type TY is “one-way charging,” the charging frequency FQ is “high frequency,” the frequent arrival time FAT is “other cases,” and the frequent duration stay FDS is “other cases”; and so on.

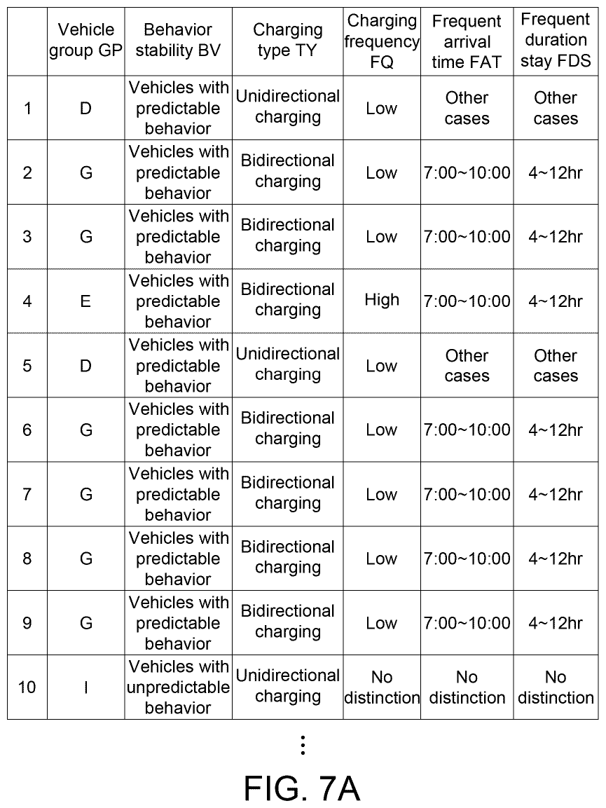

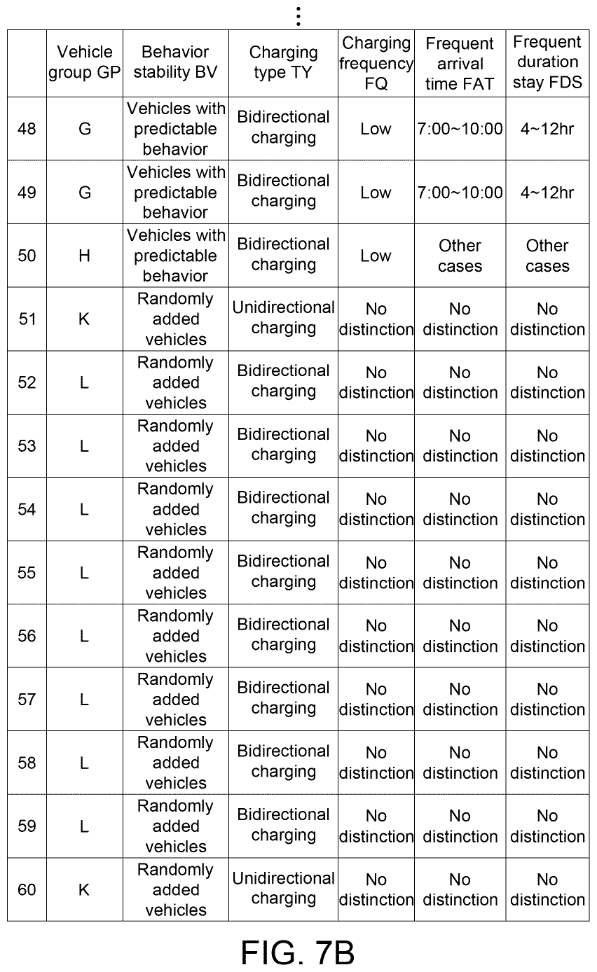

Please refer to FIGS. 7A to 7B, which illustrate an example of the vehicle groups GP for a number of simulation vehicles VC. FIGS. 7A to 7B are merely an example, and this disclosure is not limited to the example shown in FIGS. 7A to 7B. Once the number of the simulation vehicles is determined, the vehicle groups GP could be configured according to the aforementioned probability PB. For example, among 60 vehicles VC, the first 50 vehicles are assigned to the vehicle groups GP labeled “A” to “J” according to the probability PB, while the last “randomly added” vehicles are assigned to the vehicle groups GP labeled “K” and “L” based on a 20% probability for “one-way charging” and an 80% probability for “two-way charging with no fixed behavior”.

Next, in the step S132 of FIG. 4, as shown in FIG. 2, the arrival time simulation unit 132 obtains the simulation arrival time AT for a vehicle VC according to the vehicle group GP. For example, different vehicle groups GP are simulated using different methods. By considering the characteristics of the vehicle group GP, the simulation arrival time AT that closely approximates real-world data could be obtained.

Next, in the step S133 of FIG. 4, as shown in FIG. 2, the duration stay simulation unit 133 obtains the simulation duration stay DS for a specific vehicle VC according to the vehicle group GP. For example, different vehicle groups GP will be simulated using different methods. By considering the characteristics of the vehicle group GP, the simulation duration stay DS that closely approximates real-world data could be obtained.

Then, in the step S134 of FIG. 4, as shown in FIG. 2, the charging demand simulation unit 134 obtains the simulation charging demand CD for a specific vehicle VC according to the vehicle group GP. For example, different vehicle groups GP will be simulated using different methods. By considering the characteristics of the vehicle group GP, the simulation charging demand CD that closely approximates real-world data could be obtained.

Next, in the step S135 of FIG. 4, the control unit 190 obtains other information such as the charging type TY, a charging rate CR, a target power TG, and a battery capacity BC. The charging type TY is determined according to the vehicle group GP, for example. The charging rate CR, the target power TG, and the battery capacity BC are randomly set within a predetermined range, for example.

Then, in the step S136 of FIG. 4, the leaving time simulation unit 135 calculates the simulation leaving time LT according to the simulation arrival time AT and the simulation duration stay DS. For example, the leaving time simulation unit 135 may calculate the simulation leaving time LT using the following equation (1).

simulation leaving time LT=simulation arrival time AT+simulation duration stay DS. (1)

Next, in the step S137 of FIG. 4, the charging duration simulation unit 136 calculates the simulation charging duration CT according to the simulation charging demand CD and the charging rate CR. For example, the charging duration simulation unit 136 calculates the simulation charging duration CT using the following equation (2).

$$simulation charging duration CT = \frac{simulation charging demand CD}{charging rate CR} \qquad ( 2 )$$

Then, in the step S138 of FIG. 4, the initial power simulation unit 137 calculates the simulation initial power SC according to the target power TG, the simulation charging demand CD, and the battery capacity BC. For example, the initial power simulation unit 137 could calculate the simulation initial power SC using the following equation (3).

$$simulation initial power SC = target power TG - \frac{simulation charging demand CD}{battery capacity BC} \qquad ( 3 )$$

Each piece of the vehicle charging behavior data SMD obtained using the aforementioned method includes information such as the simulation arrival time AT, the simulation duration stay DS, the simulation charging demand CD, the simulation leaving time LT, the simulation charging duration CT, the simulation initial power SC, the charging type TY, the charging rate CR, the target power TG, and the battery capacity BC. This vehicle charging behavior data SMD will be stored in the storage unit 180.

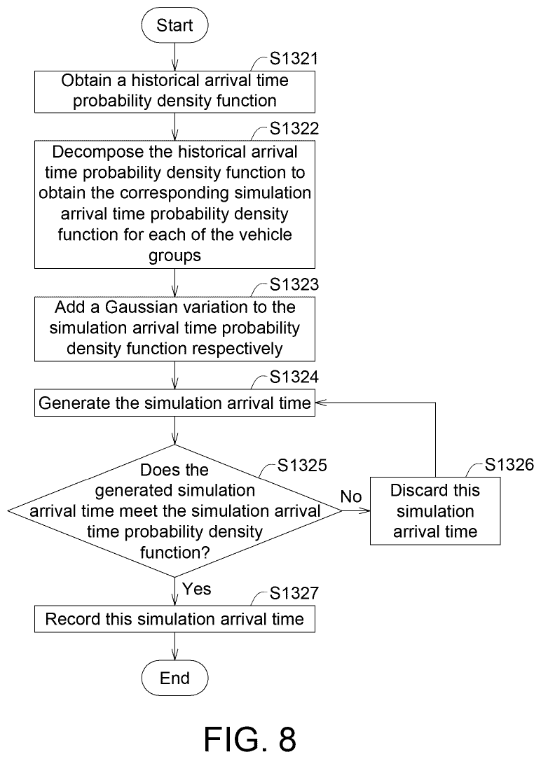

Please refer to FIG. 8, which illustrates the detailed flowchart of the step S132 according to an embodiment of the present disclosure. The step S132 includes, for example, steps S1321 to S1327. In the step S1321, the historical data acquisition element 1321 obtains a historical arrival time probability density function PDF2.

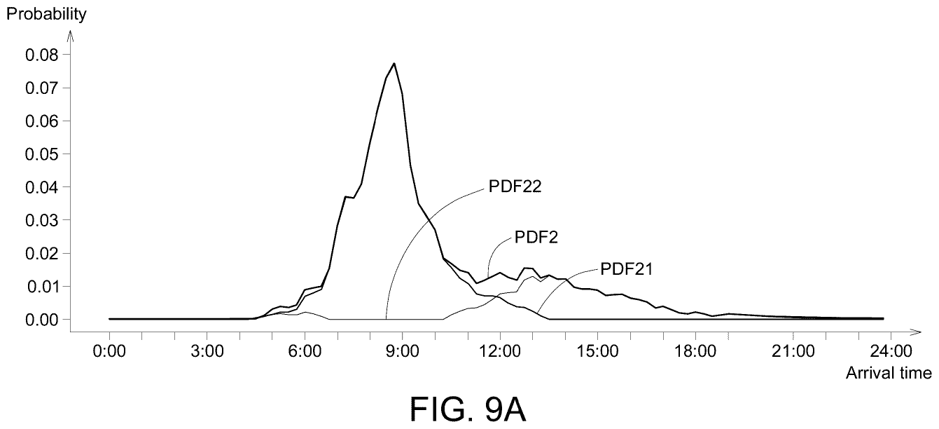

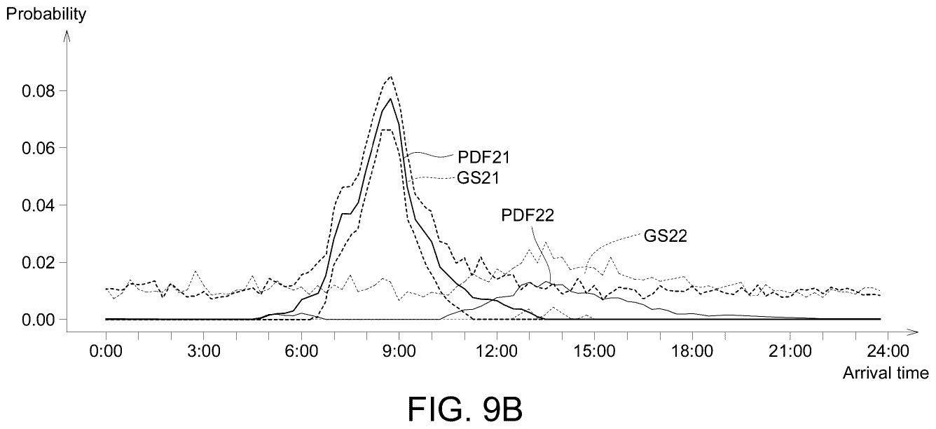

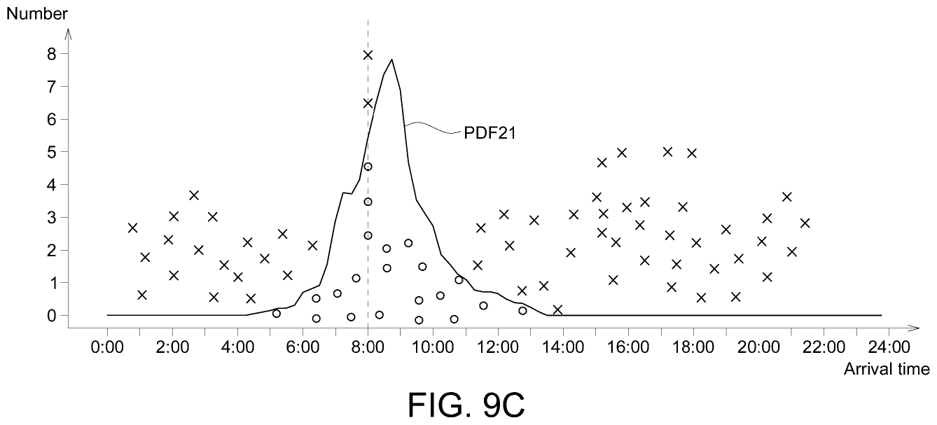

Please refer to FIG. 9A, which illustrates the historical arrival time probability density function PDF2 and two simulation arrival time probability density functions PDF21 and PDF22 according to one embodiment of the present disclosure. The historical arrival time probability density function PDF2 is a distribution function derived from statistical analysis of actual historical data regarding arrival times.

Next, in the step S1322 of FIG. 8, as shown in FIGS. 2 and 9A, the function decomposition element 1322 decomposes the historical arrival time probability density function PDF2 to obtain the corresponding simulation arrival time probability density function PDF21 (or PDF22) for each of the vehicle groups GP. The vehicle groups GP labeled “A”, “C”, “E”, and “G” have the frequent arrival time FAT of “7:00-10:00,” and these vehicle groups GP correspond to the simulation arrival time probability density function PDF21. The vehicle groups GP labeled “B”, “D”, “F”, and “H” have the frequent arrival time FAT of “other times,” and these vehicle groups GP correspond to the simulation arrival time probability density function PDF22.

Then, in the step S1323 of FIG. 8, as shown in FIG. 2, the variation enhancement element 1323 adds a Gaussian variation GS21 (or GS22) to the simulation arrival time probability density function PDF21 (or PDF22), respectively. Please refer to FIG. 9B, which illustrates the simulation arrival time probability density function PDF21 (or PDF22) after adding the Gaussian variation GS21 (or GS22) according to an embodiment of the present disclosure. After adding the Gaussian variation GS21, any value within a certain range of variation is considered to meet the simulation arrival time probability density function PDF21. Similarly, after adding the Gaussian variation GS22, any value within a certain range of variation is considered to meet the simulation arrival time probability density function PDF22.

Next, in the steps S1324 to S1327 of FIG. 8, the generation element 1324 uses a Monte Carlo algorithm to generate the simulation arrival time AT that meets the simulation arrival time probability density function PDF21 (or PDF22).

For example, please refer to FIG. 9C, which illustrates an example of the Monte Carlo algorithm. In the step S1324 of FIG. 8, the generation element 1324 generates the simulation arrival time AT.

Then, in the step S1325, the generation element 1324 determines whether the generated simulation arrival time AT meets the simulation arrival time probability density function PDF21 (or PDF22). If the generated simulation arrival time AT does not meet the simulation arrival time probability density function PDF21 (or PDF22), the process proceeds to the step S1326; if it does meet the simulation arrival time probability density function PDF21, the process proceeds to the step S1327.

In the step S1326, as shown at the intersection in FIG. 9C, the generation element 1324 discards this simulation arrival time AT.

In the step S1327, as shown by the circled point in FIG. 9C, the generation element 1324 records this simulation arrival time AT. In other words, through the Monte Carlo algorithm, it is possible to successfully generate the simulation arrival time AT that meets the simulation arrival time probability density function PDF21 (or PDF22).

After generating the simulation arrival time AT, the step S132 in FIG. 4 is completed.

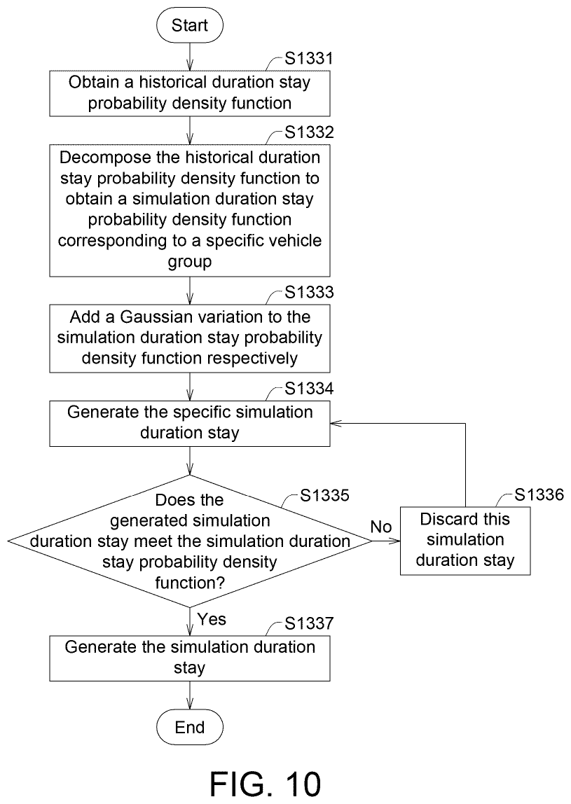

Please refer to FIG. 10, which illustrates the detailed flowchart of the step S133 according to an embodiment of the present disclosure. The step S133 includes, for example, steps S1331 to S1337. In the step S1331, as shown in FIG. 2, the historical data acquisition element 1331 obtains a historical duration stay probability density function PDF3.

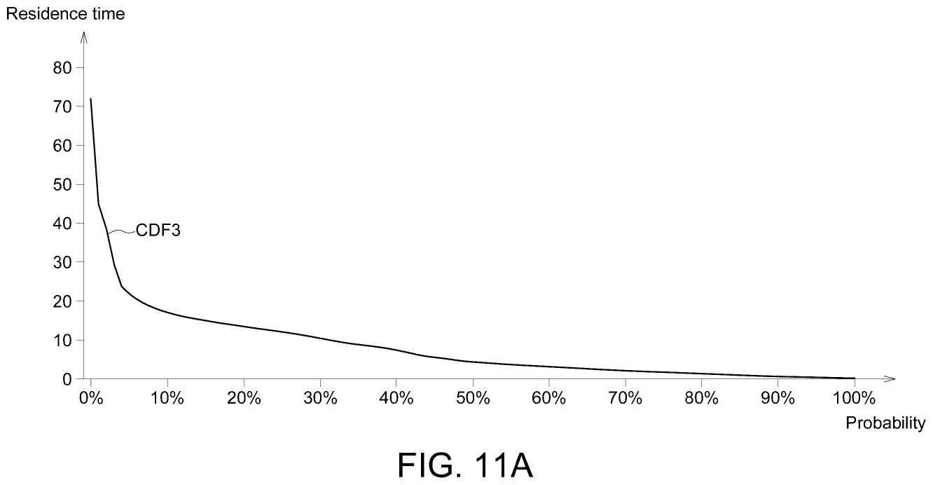

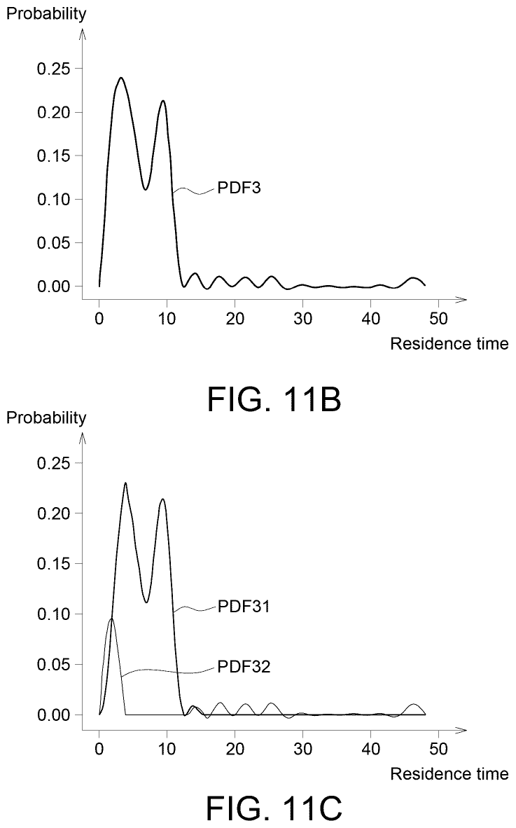

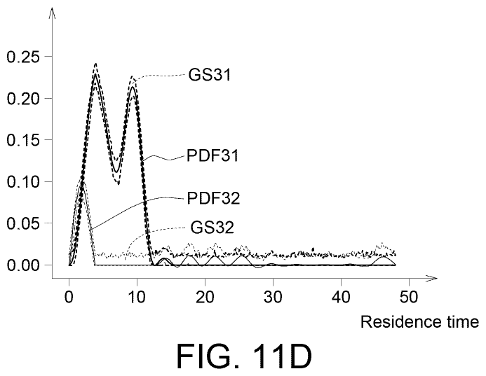

Please refer to FIG. 11A, which illustrates the historical residence time cumulative distribution function (CDF) CDF3 according to one embodiment of the present disclosure. The historical residence time cumulative distribution function CDF3 is a cumulative distribution function calculated according to actual historical data regarding residence time.

Please refer to FIG. 11B, which illustrates the historical duration stay probability density function PDF3 according to an embodiment of the present disclosure. This historical duration stay probability density function PDF3 is a statistical distribution function derived from real historical data regarding the duration of stays. The historical duration stay probability density function PDF3 in FIG. 11B could be obtained from the historical residence time cumulative distribution function CDF3 shown in FIG. 11A.

Next, in the step S1332 of FIG. 10, as shown in FIG. 2, the function decomposition element 1332 decomposes the historical duration stay probability density function PDF3 to obtain a simulation duration stay probability density function PDF31 (or PDF32) corresponding to a specific vehicle group GP. Referring to FIG. 11C, it illustrates the simulation duration stay probability density functions PDF31 and PDF32 according to an embodiment of the present disclosure. The vehicle groups GP labeled “A”, “C”, “E”, and “G” have the frequent duration stay FDS of “4-12 hours”; these vehicle groups GP correspond to the simulation duration stay probability density function PDF31. The vehicle groups GP labeled “B”, “D”, “F”, and “H” have the frequent duration stay FDS of “other cases”; these vehicle groups GP correspond to the simulation duration stay probability density function PDF32.

Then, in the step S1333 of FIG. 10, as shown in FIG. 2, the variation enhancement element 1333 adds a Gaussian variation GS31 (or GS32) to the simulation duration stay probability density function PDF31 (or PDF32), respectively. Please refer to FIG. 11D, which illustrates the simulation duration stay probability density function PDF31 (or PDF32) after adding the Gaussian variation GS31 (or GS32) according to an embodiment of the present disclosure. After adding the Gaussian variation GS31, any value within a certain range of variation is considered to meet the simulation duration stay probability density function PDF31. Similarly, after adding the Gaussian variation GS32, any value within a certain range of variation is considered to meet the simulation duration stay probability density function PDF32.

Next, in the steps S1334 to S1337 of FIG. 10, the generation element 1334 uses a Monte Carlo algorithm to generate the simulation duration stay DS that meets the simulation duration stay probability density function PDF31 (or PDF32).

For example, in the step S1334 of FIG. 10, the generation element 1334 generates the specific simulation duration stay DS.

Then, in the step S1335, the generation element 1334 determines whether the generated simulation duration stay DS meets the simulation duration stay probability density function PDF31 (or PDF32). If the generated simulation duration stay DS does not meet the simulation duration stay probability density function PDF31 (or PDF32), then the process proceeds to the step S1336; if the generated simulation duration stay DS meets the simulation duration stay probability density function PDF31, then the process proceeds to the step S1337.

In the step S1336, the generation element 1334 discards this simulation duration stay DS.

In the step S1337, the generation element 1324 generates the simulation duration stay DS. In other words, through the Monte Carlo algorithm, it can successfully generate the simulation duration stay DS that meets the simulation duration stay probability density function PDF31 (or PDF32).

After generating the simulation duration stay DS, the step S133 in FIG. 4 is completed.

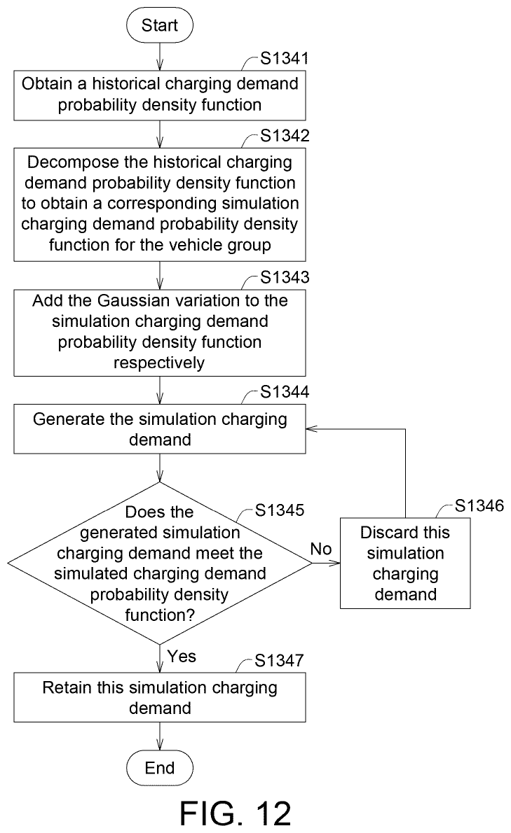

Please refer to FIG. 12, which illustrates the detailed flowchart of the step S134 according to an embodiment of the present disclosure. The step S134 includes, for example, steps S1341 to S1347. In the step S1341, as shown in FIG. 2, the historical data acquisition element 1341 obtains a historical charging demand probability density function PDF4.

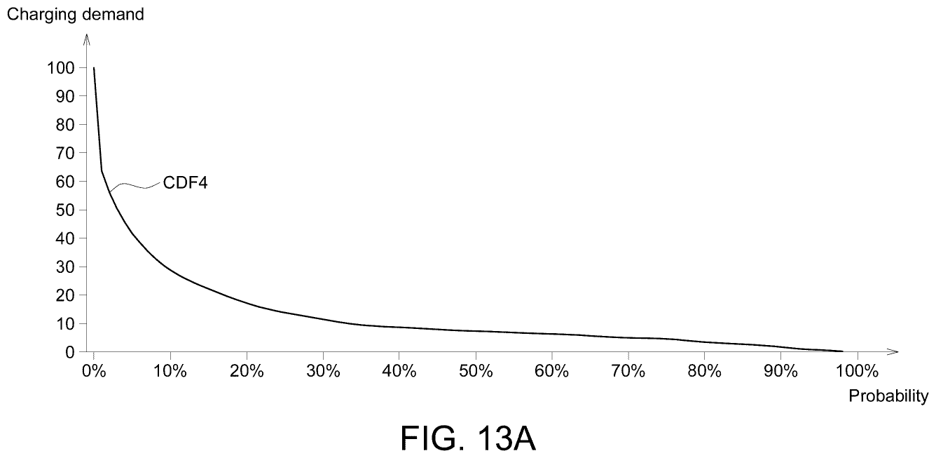

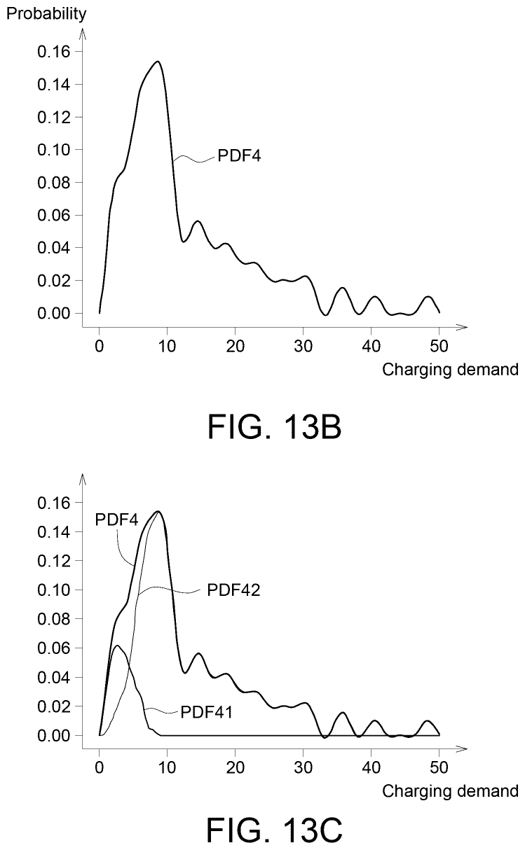

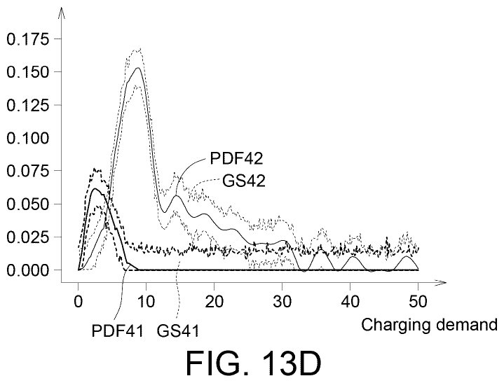

Please refer to FIG. 13A, which illustrates the historical charging demand cumulative distribution function CDF4 according to an embodiment of the present disclosure. This historical charging demand cumulative distribution function CDF4 is a cumulative distribution function calculated based on historical, real-world data regarding charging demand.

Please refer to FIG. 13B, which illustrates the historical charging demand probability density function PDF4 according to an embodiment of the present disclosure. This historical charging demand probability density function PDF4 is a statistical distribution function derived from historical, real-world data regarding charging demand. The historical charging demand probability density function PDF4 in FIG. 13B could be obtained from the historical charging demand cumulative distribution function CDF4 shown in FIG. 13A.

Next, in the step S1342 of FIG. 12, as shown in FIG. 2, the function decomposition element 1342 decomposes the historical charging demand probability density function PDF4 to obtain a corresponding simulation charging demand probability density function PDF41 (or PDF42) for the vehicle group GP. Please refer to FIG. 13C, which illustrates the simulation charging demand probability density functions PDF41 and PDF42 according to an embodiment of the present disclosure. The vehicle groups GP labeled “A”, “B”, “E”, and “F” have a “high charging frequency,” and correspond to the simulation charging demand probability density function PDF41. For the vehicle groups GP labeled “C”, “D”, “G”, and “H”, the charging frequency FQ is classified as “low charging frequency”. These vehicle groups GP correspond to the simulation charging demand probability density function PDF42.

Then, in the step S1343 of FIG. 12, as shown in FIG. 2, the variation enhancement element 1343 adds the Gaussian variation GS41 (or GS42) to the simulation charging demand probability density function PDF41 (or PDF42), respectively. Please refer to FIG. 13D, which illustrates the simulation charging demand probability density function PDF41 (or PDF42) added with the Gaussian variation GS41 (or GS42) according to an embodiment of the present disclosure. After adding the Gaussian variation GS41, any value within a certain range of variation is considered to meet the simulation charging demand probability density function PDF41. Similarly, after adding the Gaussian variation GS42, any value within a certain range of variation is considered to meet the simulation charging demand probability density function PDF42.

Next, in the steps S1344 to S1347 of FIG. 12, the generation element 1344 uses a Monte Carlo algorithm to generate a simulated charging demand CD that meets the simulation charging demand probability density function PDF41 (or PDF42).

For example, in the step S1344 of FIG. 12, the generation element 1344 generates the simulation charging demand CD.

Then, in the step S1345, the generation element 1344 determines whether the generated simulation charging demand CD meets the simulated charging demand probability density function PDF41 (or PDF42). If the generated simulation charging demand CD does not meet the simulation charging demand probability density function PDF41 (or PDF42), then the process proceeds to the step S1346; if the generated simulation charging demand CD meets the simulation charging demand probability density function PDF41, then the process proceeds to the step S1347.

In the step S1346, the generation element 1334 discards this simulation charging demand CD.

In the step S1347, the generation element 1324 retains this simulation charging demand CD. In other words, through the Monte Carlo algorithm, the simulation charging demand CD that meets the simulation charging demand probability density function PDF41 (or PDF42) is successfully generated.

After the simulation charging demand CD is generated, the step S134 in FIG. 4 is completed.

According to the above embodiment, the simulation system 1000 could use appropriate clustering techniques to determine the distribution of the vehicle charging behavior data and then simulate various information accordingly. When the vehicle charging behavior data is difficult to collect, the present disclosure utilizes the simulation system 1000 to rapidly generate multiple vehicle charging behavior data SMD. This reduces the time required to infer the charge-discharge schedule CDS from months to days, significantly accelerating the deployment of charging stations.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A simulating method for vehicle charging behavior data in a charging station, comprising:
determining a vehicle group of a vehicle;
obtaining a simulation arrival time of the vehicle according to the vehicle group;
obtaining a simulation duration stay of the vehicle according to the vehicle group; and
obtaining a simulation charging demand of the vehicle according to the vehicle group.

2. The simulating method for the vehicle charging behavior data in the charging station according to claim 1, wherein the step of obtaining the simulation arrival time of the vehicle according to the vehicle group comprises:
obtaining a historical arrival time probability density function (PDF);
decomposing the historical arrival time probability density function to obtain the simulation arrival time probability density function corresponding to the vehicle group; and
generating the simulation arrival time that meets the simulation arrival time probability density function via a Monte Carlo algorithm.

3. The simulating method for the vehicle charging behavior data in the charging station according to claim 2, wherein the step of obtaining the simulation arrival time of the vehicle according to the vehicle group further comprises:
adding a Gaussian variation to the simulation arrival time probability density function.

4. The simulating method for the vehicle charging behavior data in the charging station according to claim 1, wherein the step of obtaining the simulation duration stay of the vehicle according to the vehicle group comprises:
obtaining a historical duration stay probability density function;
decomposing the historical duration stay probability density function to obtain a simulation duration stay probability density function corresponding to the vehicle group; and
generating the simulation duration stay that meets the simulation duration stay probability density function via a Monte Carlo algorithm.

5. The simulating method for the vehicle charging behavior data in the charging station according to claim 4, wherein the step of obtaining the simulation duration stay of the vehicle according to the vehicle group further comprises:
adding a Gaussian variation to the simulation duration stay probability density function.

6. The simulating method for the vehicle charging behavior data in the charging station according to claim 1, wherein the step of obtaining the simulation charging demand of the vehicle according to the vehicle group comprises:
obtaining a historical charging demand probability density function;
decomposing the historical charging demand probability density function to obtain a simulation charging demand probability density function corresponding to the vehicle group; and
generating the simulation charging demand that meets the simulation charging demand probability density function via a Monte Carlo algorithm.

7. The simulating method for the vehicle charging behavior data in the charging station according to claim 6, wherein the step of obtaining the simulation charging demand of the vehicle according to the vehicle group further comprises:
adding a Gaussian variation to the simulation charging demand probability density function.

8. The simulating method for the vehicle charging behavior data in the charging station according to claim 6, wherein the historical charging demand probability density function is obtained from a historical charging demand cumulative distribution function (CDF).

9. The simulating method for the vehicle charging behavior data in the charging station according to claim 1, wherein the vehicle group is classified according to a behavior stability.

10. The simulating method for the vehicle charging behavior data in the charging station according to claim 1, wherein the vehicle group is classified by a charging type.

11. The simulating method for the vehicle charging behavior data in the charging station according to claim 1, wherein the vehicle group is classified according to a charging frequency.

12. The simulating method for the vehicle charging behavior data in the charging station according to claim 1, wherein the vehicle group is classified according to a frequent arrival time and a frequent duration stay.

13. A simulation system for vehicle charging behavior data, comprising:
a vehicle group determination unit, used for determining a vehicle group of a vehicle;
an arrival time simulation unit, used for obtaining a simulation arrival time of the vehicle according to the vehicle group;
a duration stay simulation unit, used for obtaining a simulation duration stay of the vehicle according to the vehicle group; and
a charging demand simulation unit, used for obtaining a simulation charging demand of the vehicle according to the vehicle group.

14. The simulation system for the vehicle charging behavior data according to claim 13, wherein the arrival time simulation unit comprises:
a historical data acquisition element, used for obtaining a historical arrival time probability density function (PDF);
a function decomposition element, used for decomposing the historical arrival time probability density function to obtain the simulation arrival time probability density function corresponding to the vehicle group; and
a generation element, used for generating the simulation arrival time that meets the simulation arrival time probability density function via a Monte Carlo algorithm.

15. The simulation system for the vehicle charging behavior data according to claim 14, wherein the arrival time simulation unit further comprises:
a variation enhancement element, used for adding a Gaussian variation to the simulation arrival time probability density function.

16. The simulation system for the vehicle charging behavior data according to claim 13, wherein the duration stay simulation unit comprises:
a historical data acquisition element, used for obtaining a historical duration stay probability density function;
a function decomposition element, used for decomposing the historical duration stay probability density function to obtain a simulation duration stay function probability density corresponding to the vehicle group; and
a generation element, used for generating the simulation duration stay that meets the simulation duration stay probability density function via a Monte Carlo algorithm.

17. The simulation system for the vehicle charging behavior data according to claim 16, wherein the duration stay simulation unit further comprises:
a variation enhancement element, used for adding a Gaussian variation to the simulation duration stay probability density function.

18. The simulation system for the vehicle charging behavior data according to claim 13, wherein the charging demand simulation unit comprises:
a historical data acquisition element, used for obtaining a historical charging demand probability density function;
a function decomposition element, used for decomposing the historical charging demand probability density function to obtain a simulation charging demand probability density function corresponding to the vehicle group; and
a generation element, used for generating the simulation charging demand that meets the simulation charging demand probability density function via a Monte Carlo algorithm.

19. The simulation system for the vehicle charging behavior data according to claim 18, wherein the charging demand simulation unit further comprises:
a variation enhancement element, used for adding a Gaussian variation to the simulation charging demand probability density function.

20. The simulation system for the vehicle charging behavior data according to claim 18, wherein the historical data acquisition element obtains the historical charging demand probability density function from a historical charging demand cumulative distribution function (CDF).
